(19) United States
(12) Patent Application Publication
(10) Pub. No.: US 2008/0242522 A1
(43) Pub. Date: Oct. 2, 2008

(54) LINEAR UNIT

(76) Inventors: Bernhard Keller, Wasserlosen (DE); Roland Hoherz, Kuetzberg (DE); Sven Anhut, Schweinfurt (DE)

Correspondence Address: Striker, Striker & Stenby, 103 East Neck Road, Huntington, NY, 11743, US

(21) Appl. No.: 12/013,821

(22) Filed: Jan. 14, 2008

(30) Foreign Application Priority Data
Mar. 30, 2007 (DE) 20 2007 004 693.6

(51) Int. Cl. B23Q 1/58; B23Q 5/04

(52) U.S. Cl. 483/13; 483/55; 409/174

(57) ABSTRACT

A linear unit has a drive unit, a stator, a drive roller connected to the drive unit, a freewheeling roller supported on the stator adjacent to one of longitudinal ends of the stator, the drive belt being wound around the drive roller and around the freewheeling roller, a traveler movable along the stator by the drive belt, the drive belt being connected to the traveler in at least one fastening point, so that a distance between an end of the traveler which is oriented toward an end of the stator associated with the freewheeling roller, and the fastening point situated the closest to the end of the traveler is at least equal to a radius of the freewheeling roller.

### CROSS-REFERENCE TO A RELATED APPLICATION

The invention described and claimed hereinbelow is also described in German Patent Application DE 20 2007 004 693.6 filed on Mar. 30, 2007. This German Patent Application, whose subject matter is incorporated here by reference, provides the basis for a claim of priority of invention under 35 U.S.C. 119(a)-(d).

### BACKGROUND OF THE INVENTION

The invention relates to a linear unit with a traveler that can be moved along a stator by means of a drive belt, in which the drive belt is wound around a drive roller, which is connected to a drive unit, and around a freewheeling roller; the freewheeling roller is supported on the stator adjacent to one of the longitudinal ends of the stator; and the drive belt is connected to the traveler in at least one fastening point.

A linear unit of this kind is known, for example, from DE 37 43 577 C1. In this linear unit, the freewheeling roller is supported on an end plate of the linear unit by means of tensioning screws that engage in threaded bores of the bearing shaft of the freewheeling roller. In addition, the drive belt is connected to the traveler at two fastening points, which are situated adjacent to the ends of the traveler oriented toward the freewheeling roller and oriented away from it. In this arrangement, it is disadvantageous that the traveler cannot make use of the full length of the stator as it travels along it.

### SUMMARY OF THE INVENTION

By contrast, the object of the invention is to disclose a linear unit of the type mentioned at the beginning in which the traveler can make use of a greater length of the stator when moving along it.

This object is attained according to the invention by means of a linear unit of the type mentioned at the beginning in which the distance between the end of the traveler, which is oriented toward the end of the stator associated with the freewheeling roller, and the fastening point situated the closest to this end of the traveler is at least equal to the radius of the freewheeling roller. Since at a maximum, the traveler can move in the direction toward the freewheeling roller until the fastening point closest to the freewheeling roller is situated precisely at the apex of the freewheeling roller, i.e. the point at which the drive belt comes into contact with the freewheeling roller and begins its deflection movement around the freewheeling roller, and according to the invention, in this position, there is still a segment of the traveler protruding beyond the apex, the length of which is at least equal to the radius of the freewheeling roller, the traveler is therefore able to make use of a significantly greater length of the stator for its movement.

In order to be able to make use of an even greater length of the stator for the movement of the traveler, according to a modification of the invention, the distance is at least equal to the radius of the freewheeling roller determined by taking into account the drive belt that is wound around it.

Depending on the respective construction of the linear unit, when determining the distance, it is additionally or alternatively possible to also take into account the thickness of the end plate of the linear unit.

As is intrinsically known from the prior art, the position of the freewheeling roller can be adjustable relative to the stator, which is particularly advantageous for tensioning the drive belt.

In order to stabilize the position of the freewheeling roller in the vertical direction of the linear unit and thus to be able to assure a smoother running of the drive belt, according to another aspect of the invention, it is possible for the axle or shaft of the freewheeling roller to be supported in a carriage whose position in relation to the stator can be adjusted in the longitudinal direction of the stator, for example through the use of at least one tensioning screw supported on the stator, preferably on an end plate of the stator. Since the provision of such a carriage is not yet known from the prior art, separate protection is being sought for this idea.

The carriage can advantageously be guided on the stator. If one of the parts here, i.e. the stator or carriage, has an undercut groove that encompasses associated projections of the respective other part, i.e. the carriage or stator, then this can produce a stable guidance of the carriage in both the vertical direction and the transverse direction of the linear unit.

Since the play present in the vertical direction in particular plays a decisive role in a smooth running of the drive belt, according to a modification of this aspect of the invention, play-adjusting means are provided that make it possible to adjust, preferably to reduce or eliminate, the play between the carriage and the stator. In this case, the play-adjusting means should adjust the play in the vertical direction in such a way that it is still possible, preferably just barely, to tension the drive belt, i.e. to adjust the carriage in the longitudinal direction of the stator. After the belt is tensioned, the play-adjusting means is firmly tightened in order to prevent the carriage from vibrating.

The carriage can have an essentially U-shaped form in a section extending orthogonal to the movement direction. In this case, the axle or shaft of the freewheeling roller can be supported in the two side legs of the U-shape and/or the at least one tensioning screw can engage in an end surface of at least one side leg of the U-shape and/or the carriage can be guided on the stator by means of the base leg of the U-shape and/or the play-adjusting means can be associated with the base leg of the U-shape.

In order to be able to minimize the generation of noise caused by the drive belt slapping against the traveler when the traveler is moving along the stator, according to a modification of the invention, when a plurality of fastening points are provided, they are distributed asymmetrically over the length of the traveler in its movement direction. In particular, it is advantageous if the distance between the end of the traveler oriented away from the freewheeling roller and the fastening point situated the closest to this end of the traveler is as small as possible, preferably the fastening point situated the closest to this end of the traveler is situated adjacent to the end of the traveler oriented away from the freewheeling roller.

As is intrinsically known, it is also possible according to the invention for the stator to be composed of the housing of a linear module, preferably produced from an extruded profile.

In addition, the drive belt can be a toothed belt, which is likewise intrinsically known.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a perspective view of a linear unit according to the invention;

FIG. 2 is an end view of the linear unit according to FIG. 1;

FIG. 3 is an exploded view of the tensioning device of the linear unit according to the invention; and

FIG. 4 is a schematic side view of the linear unit according to the invention.

### DESCRIPTION OF THE PREFERRED EMBODIMENTS

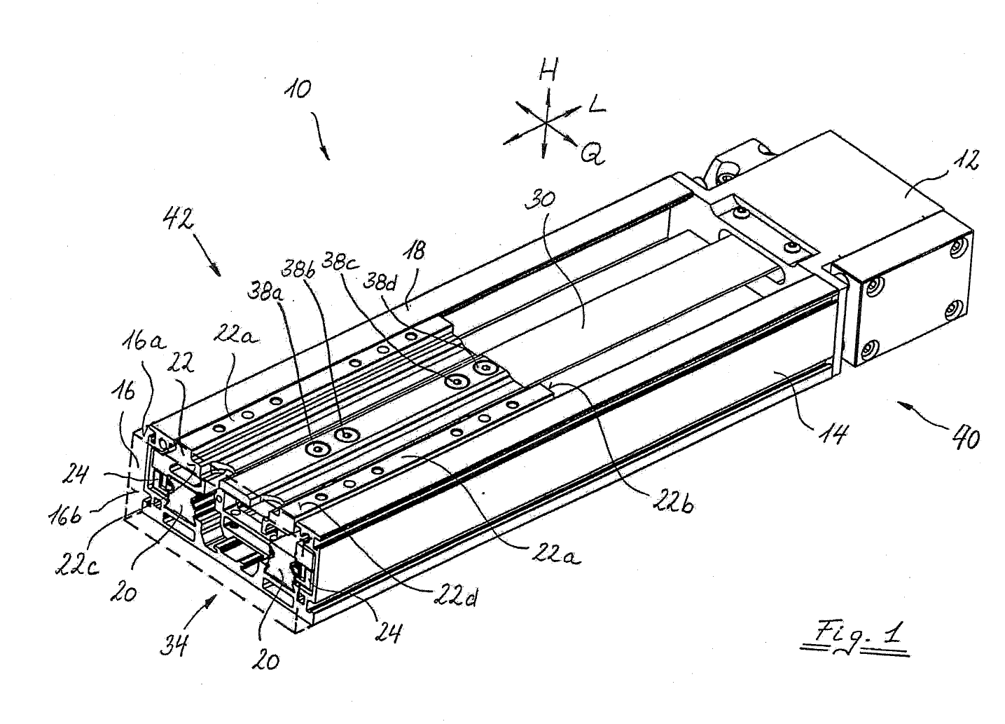

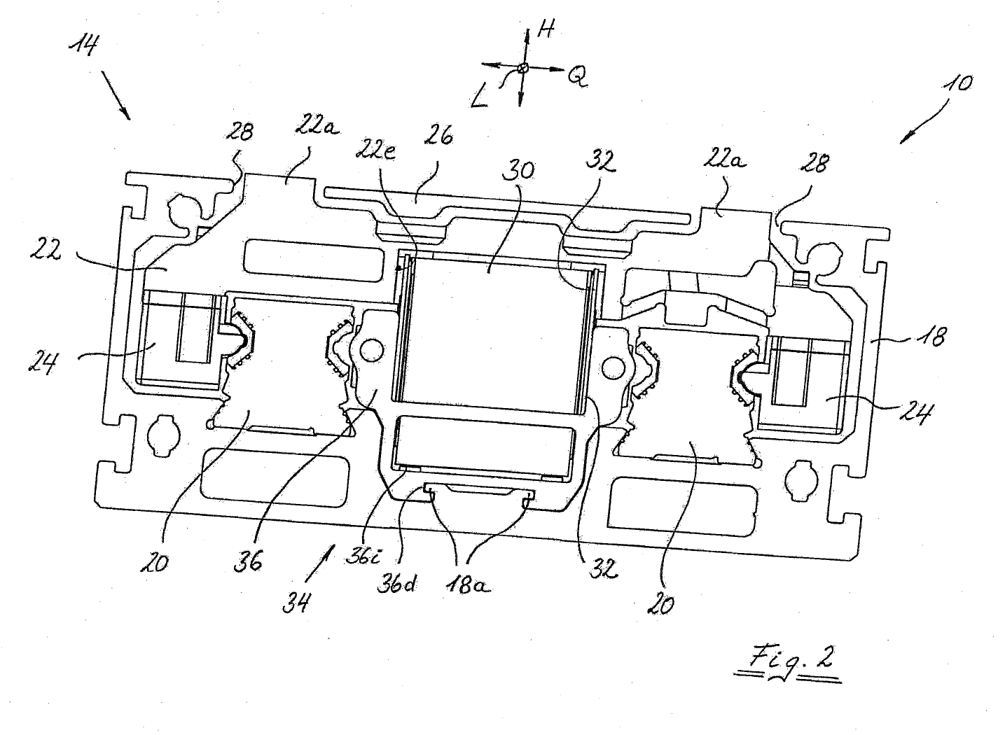

In FIG. 1, a linear unit according to the invention is labeled as a whole with the reference numeral 10. It includes a drive unit 12 and a main module unit 14; in FIG. 1, an end plate 16 of the main module unit 14 is only depicted with dashed lines in order to provide a view of the inner structure of the main module unit 14. The inner structure of the main module unit 14 is also shown in the end view according to FIG. 2.

The main module unit 14 has a housing 18 that is advantageously composed of an extruded profile with an essentially U-shaped cross-section. The base leg of the U-shape of the housing 18 has two guide rails 20 mounted to it on which guide units 24 support a table part 22 so that it is able to slide in the longitudinal direction L of the linear unit 10. As is shown only in FIG. 2, the opening between the free ends of the side legs of the U-shape of the housing 18 is covered over the length of the housing 18 by a cover plate 26 so that only two longitudinal slots 28 remain, through which two fastening strips 22a of the table part 22 protrude. A component that is to be slid by means of the linear unit 10 can be attached to the table part 22 by means of these fastening strips 22a. The cover plate 26 is fastened to the drive unit 12 at one end and to the end plate 16 at the other.

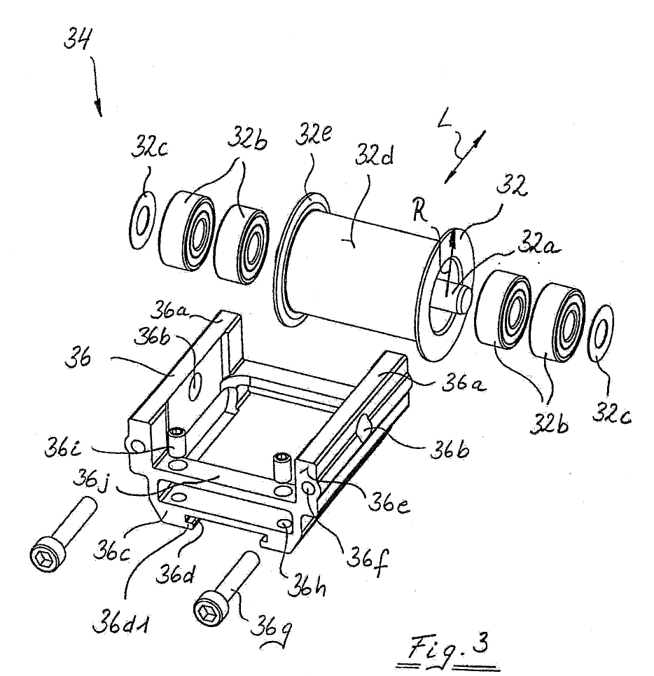

As is particularly clear from FIG. 1, the linear unit 10 according to the invention is equipped with a belt drive. The drive belt 30 of the belt drive, which is closed into an endless loop, on the one hand winds around a driven roller that is situated in the drive unit 12 and is therefore not visible in the drawing and on the other hand, winds around a freewheeling roller 32, which is situated adjacent to the end plate 16. In order to be able to tension the drive belt 30, which can for example be embodied in the form of a toothed belt, the freewheeling roller 32 is situated in a tensioning device 34 whose design and function will be explained in greater detail below particularly in conjunction with FIG. 3:

The tensioning device 34 has a carriage 36 that has an essentially U-shaped cross-section in the view shown in FIG. 2. The side legs 36a of the carriage 36 are provided with through openings 36b, which serve to accommodate the axle or shaft 32a of the freewheeling roller 32. To support the freewheeling roller 32 in rotary fashion on the axle/shaft 32a, roller bearings 32b are provided, which are secured to the axle/shaft 32a by means of shim rings 32c. On its base leg 36c, the carriage 36 is provided with an undercut groove 36d that engages with correspondingly embodied projections 18a of the base leg 36c of the housing 18 (see FIG. 2). Threaded bores 36f extending in the longitudinal direction L are let into the end surfaces 36e of the side legs 36a of the carriage 36. Two tensioning screws 36g, which pass through the end plate 6 engage in these threaded bores 36f and rest with their heads against the end late 16. In this way, tightening the tensioning screws 36g causes the carriage 36 to move toward the endplate 16, thus making it possible to tension the drive belt 30.

In order to reduce a play that exists between the carriage 36 and the housing 18 or to set it to an amount that permits a desired mobility of the carriage 36 in the longitudinal direction L, threaded bores 36h extending in a vertical direction H are provided in the base leg 36c of the carriage 36 on both sides of the groove 36d; these threaded bores 36h extend through the base leg 36c and set screws 36i can be screwed into them. If the lower end surfaces of the set screws 36i rest against the base leg of the housing 18, then the projections 36d1 delimiting the groove 36d are pressed against the projections 18a, thus reducing or eliminating a play that may be present between the carriage 36 and the housing 18.

It should also be noted that in order to stabilize the shape of the carriage 36, reinforcing bridge pieces 36j are also provided that extend parallel to the carriage's base leg 36c.

It should further be noted that if the width of the base leg 36c essentially corresponds to the width of the roller 32, then it is possible to achieve a particularly compact design.

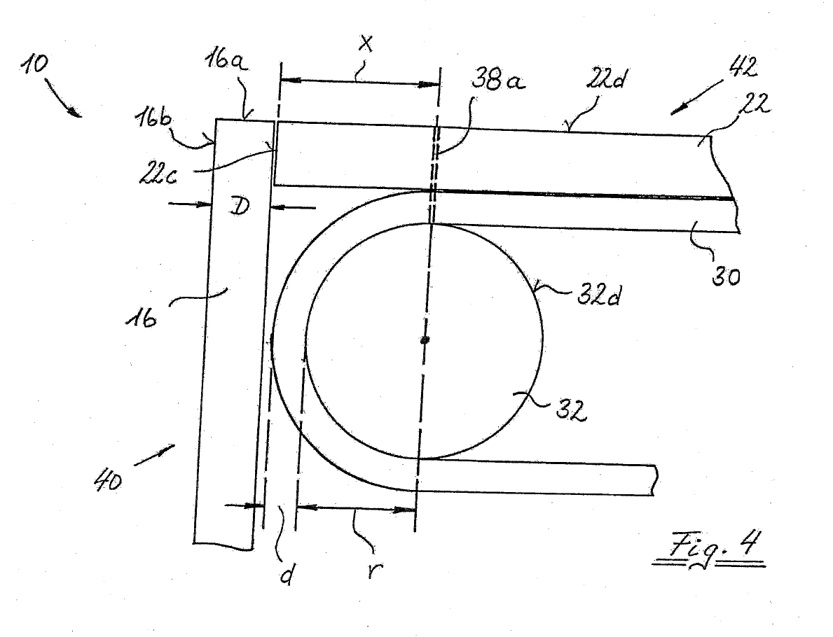

As shown in FIG. 1, the drive belt 30 is fastened to the table part 22 at four fastening points 38a, 38b, 38c, and 38d. As is easily visible, these fastening points are distributed nonuniformly in the longitudinal direction L of the table part 22. The fastening points 38c and 38d are situated closer to the end 22b of the table part 22 oriented away from the freewheeling roller 32 than the fastening points 38a and 38b situated at the end 22c of the table part 22 oriented toward the freewheeling roller 32. The important thing for the present invention is the fact that, as particularly shown in FIG. 4, the fastening point 38a, which is the fastening point situated closest to the end 22c of the table part 22, has a distance x from this end 22c that is greater than the radius r of the freewheeling roller 32, and preferably, is even greater than the sum of the radius r and the thickness d of the drive belt 30.

If a freewheeling roller 32 of the kind shown in FIG. 2 is used, i.e. a roller whose cylindrical deflection surface 32d is bounded by two limiting disks or limiting rings 32e, then when the radius R of the limiting disks/limiting rings 32e is greater than the sum of the radius r of the cylindrical deflection surface 32d and the thickness d of the drive belt 30, it is preferable for the distance x to be greater than this radius R.

If the main module unit 14 is embodied so that the top 22d of the table part 22 is not flush with the top 16a of the end plate 16, but instead protrudes beyond it so that the table part 22 can be moved until it is above the end plate 16, then the distance x can be selected to be even greater, for example by the thickness D of the end plate 16 so that the end 22c of the table part 22 ends essentially flush with the end surface 16b of the end plate 16.

In this way, the entire length of the main module unit 14 can be used for the movement of the table part 22.

It should also be noted that a recess 22e is provided in the end 22c of the table part 22, which extends into the table part 22 from this end 22c. In the position of the linear unit 10 shown in FIG. 1, the freewheeling roller 32 is at least partially accommodated in this recess 22e. It is therefore possible to assure that the housing 18 of the main module unit 14 has a low structural height, i.e. a small dimension in the vertical direction H, despite the implementation of the present invention.

It should furthermore be noted that at least the drive unit 12, the housing 18, the end plate 16, and the guide rails 22 constitute the stator 40 of the linear unit 10 and that at least the table part 22 and the guide units 24 constitute the traveler 42 of the linear unit 10.

It will be understood that each of the elements described above, or two or more together, may also find a useful application in other types of constructions differing from the type described above.

While the invention has been illustrated and described as embodied in a linear unit, it is not intended to be limited to the details shown, since various modifications and structural changes may be made without departing in any way from the spirit of the present invention.

Without further analysis, the foregoing will so fully reveal the gist of the present invention that others can, be applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A linear unit, comprising a drive unit; a stator; a drive roller connected to said drive unit; a freewheeling roller supported on said stator adjacent to one of longitudinal ends of said stator; said drive belt being wound around said drive roller and around said freewheeling roller; a traveler movable along said stator by said drive belt, said drive belt being connected to said traveler in at least one fastening point, so that a distance between an end of said traveler which is oriented toward an end of said stator associated with said freewheeling roller, and said fastening point situated the closest to said end of said traveler is at least equal to a radius of said freewheeling roller.

2. A linear unit as defined in claim 1, wherein said distance is at least equal to a radius of said freewheeling roller determined by taking into account said drive belt that is wound around said freewheeling roller.

3. A linear unit as defined in claim 1; and further comprising an end plate wherein said distance is selected so that it is determined by taking into account a thickness of an end plate.

4. A linear unit as defined in claim 1, wherein said freewheeling roller has a position which is adjustable in relation to said stator.

5. A linear unit as defined in claim 1; and further comprising a carriage, wherein an axle or a shaft of said freewheeling roller is supported in said carriage, and said carriage has a position relative to said stator which is adjustable in a longitudinal direction of said stator.

6. A linear unit as defined in claim 5; and further comprising at least one tensioning screw supported on said stator and configured for adjusting said position of said carriage relative to said stator.

7. A linear unit as defined in claim 6, wherein said at least one tensioning screw is positioned on an end plate of said stator.

8. A linear unit as defined in claim 5, wherein said carriage is guided on said stator.

9. A linear unit as defined in claim 5, wherein one of parts selected from the group consisting of said stator and said carriage has an undercut groove that encompasses associated projections of the other of said parts.

10. A linear unit as defined in claim 5; and further comprising plate-adjusting means configured for adjusting a plate between said carriage and said stator.

11. A linear unit as defined in claim 5, wherein said carriage has a substantially U-shaped form in a section extending orthogonal to a movement direction.

12. A linear unit as defined in claim 1, wherein the axle or the shaft of the freewheeling roller is supported in two side legs of a U-shape of said carriage.

13. A linear unit as defined in claim 6, wherein said at least one tensioning screw engages in an end surface of at least one side leg of a U-shape of said carriage.

14. A linear unit as defined in claim 11, wherein said carriage is guided on said stator by a base leg of a U-shape.

15. A linear unit as defined claim 11; and further comprising plate-adjusting means associated with a base leg of a U-shape of said carriage.

16. A linear unit as defined in claim 1; and further comprising a plurality of said fastening points that are distributed non-uniformly in a movement direction of said traveler.

17. A linear unit as defined in claim 1, wherein said stator is composed of a housing of the linear unit.

18. A linear unit as defined in claim 17, wherein said housing is configured as an extruded profile.

19. A linear unit as defined in claim 1, wherein said drive belt is a toothed belt.

20. A linear unit, comprising a drive unit; a stator; a drive roller connected to said drive unit; a freewheeling roller supported on said stator adjacent to one of longitudinal ends of said stator; said drive belt being wound around said drive roller and around said freewheeling roller; a traveler movable along said stator by said drive belt, said drive belt being connected to said traveler in at least one fastening point, a carriage, wherein an axle or a shaft of said freewheeling roller is supported in said carriage, and said carriage has a position relative to said stator which is adjustable in a longitudinal direction of said stator.
